(19) United States
(12) Patent Application Publication
(10) Pub. No.: US 2025/0249456 A1
(43) Pub. Date: Aug. 7, 2025

(54) PROCESSING DEVICE

(71) Applicant: Skin2Neuron Pty Ltd, Sydney (AU)

(72) Inventor: Michael Valenzuela, Sydney (AU)

(73) Assignee: Skin2Neuron Pty Ltd, Sydney (AU)

(21) Appl. No.: 18/855,914

(22) PCT Filed: Apr. 13, 2023
(86) PCT No.: PCT/AU2023/050305

§ 371 Date: Oct. 10, 2024

(30) Foreign Application Priority Data
Apr. 13, 2022 (AU) 2022900981

(51) Int. Cl. B01L 3/00; A61J 1/14; A61J 1/20

(52) U.S. Cl. CPC B01L 3/502761; A61J 1/1406; A61J 1/1412; A61J 1/1443; A61J 1/2086; B01L 2200/027; B01L 2300/0672; B01L 2300/0681

(57) ABSTRACT

A processing device (10) for a therapeutic product or biological sample is provided with a proximal end (12b) and a distal end (12a). The device includes first and second compartments (40, 42) and a first substantially tubular portion (20). The first compartment (40) is in fluid communication with the second compartment (42) via a filtered opening (28) which is arranged in or along the first substantially tubular portion (20). The processing device (10) may be provided in kit form. A method of using the processing device (10) or kit is also disclosed.

### FIELD OF THE INVENTION

The present invention relates to a processing device for a therapeutic product or biological sample. In particular, although not exclusively, the invention relates to a processing device which is intended to be used in a centrifuge. One specific application for the processing device is in reconstitution of a thawed cell therapeutic product at the point of care. While the invention is described with particular application to reconstitution of thawed cell therapeutic products, the present processing device may have applications beyond the therapeutics field. The processing device may have application to other fields where centrifugation is required.

### BACKGROUND OF THE INVENTION

Typically, in the prior art process of reconstitution of a frozen cell therapeutic product, the product needs to go through a process of thawing, removal of cryopreservative, washing and final concentration to therapeutic dose before handover to the surgical team.

FIG. 1 illustrates a workflow for the reconstitution of a frozen cell therapeutic product. As shown in FIG. 1A, the frozen cells are delivered in a cryopreservative DSMO in a cryocontainer 1. The cells are thawed in the cryocontainer 1 as shown in FIG. 1B.

As shown in FIG. 1C, a pipette 2 is used to aspirate the contents of the cryocontainer 1 and deliver them to the spin tube 3. Such spin tubes, otherwise known as PCR tubes are well-known in the art. Typically, they comprise a closed ended container with a hinged lid. During centrifugation, the top of the spin tube 3 lies radially inward while the bottom of the spin tube lies radially outward. For convenience, the radially inward and is referred to as “proximal”, while the radially outward and is referred to as “distal”.

As shown in FIG. 1D, the spin tube 3 is then placed in the centrifuge 4. The effect of the centrifugation will be that the cells will move distally i.e. radially outward, in the spin tube 3. Upon returning the spin tube upright, the cryopreservative will lie above the cells as shown in the Figure. As shown in FIG. 1E, the cryopreservative can then be removed through the use of a pipette 2.

As shown in FIG. 1F, the pipette 2 delivers a fresh suspension solution, e.g. Ringers, for the therapeutic product. As shown in FIG. 1G, the liquid is agitated to disperse the cells in the fresh suspension solution. The spin tube 3 is then placed in the centrifuge as shown in FIG. 1H. The supernatant is then removed from the spin tube 3 with the use of the pipette as shown in FIG. 11. This wash cycle is repeated a number of times.

As shown in FIG. 1J, excess suspension is then removed from the spin tube 3 via the pipette 2. The amount of suspension removed depends upon the desired concentration for the therapeutic product. The therapeutic product is then ready for handover to the surgical team.

There are a number of problems with the current approach. Firstly, the use of the pipette requires skilled laboratory technicians to carry out the process. This is manually intensive and thus creates a bottleneck. In turn, the need for a skilled laboratory workforce creates a bottleneck for scalability. Secondly, the use of openable spin tubes (required to be opened each time the pipette is used) is risky from a biosafety point of view. This imposes high environmental control requirements which increases cost and complexity. Thirdly, the use of the pipette runs the risk of drawing up treatment cells or alternatively leaving precious cells behind.

The current approach is therefore not scalable for anything beyond early research use which limits its usefulness.

The object of the present invention is to therefore overcome or ameliorate at least one of the aforementioned disadvantages. An alternative object of the present invention is to provide the public with a useful choice over known processing devices.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In accordance with a first aspect of the present invention, there is provided a processing device for a therapeutic product or biological sample, the processing device provided with a proximal end and a distal end and including first and second compartments, the processing device including a first substantially tubular portion, wherein the first compartment is in fluid communication with the second compartment via a filtered opening which is arranged in or along the first substantially tubular portion.

The processing device may be configured for use in a centrifuge. Accordingly, the processing device may incorporate features which facilitates its use in a centrifuge, such as any commercial benchtop centrifuge. For example, the processing device may be insertable into a regular 15 ml centrifuge tube with or without an insert for securement. As such, the processing device is provided with a proximal end and a distal end, with the proximal end being disposed radially inwardly from the distal end during centrifugation.

The first substantially tubular portion may define a side wall of the first compartment. Accordingly, the filtered opening may be provided in the side wall. The filtered opening is preferably elongate. The elongate extent of the filtered opening is preferably oriented to generally or substantially align with the lengthwise direction of the first substantially tubular portion. The elongate extent of the filtered opening may be oriented in the lengthwise direction of the side wall.

The side wall may be a cylindrical side wall. Alternatively, the side wall may taper. Preferably, the sidewall tapers in a distal direction. The first substantially tubular portion may have a decreasing cross-sectional area along at least a portion of its length. This may comprise a progressive decrease or a stepped decrease or a combination of progressive and stepped decreases. Preferably the cross-sectional area decreases along its length, in the distal direction. The side wall may be conical or the first substantially tubular portion may include frusto-conical portions or quasi-frusto-conical portions.

The first substantially tubular portion may be of a complex shape. In a most preferred form of the invention, the decreasing cross-sectional area along its length is such that the centreline of the cross-sectional area progressively deviates from a central longitudinal axis of the processing device. Put another way, the first substantially tubular portion has transverse cross-sections and the centroid of the transverse cross-sections, along at least a portion of the length of the first substantially tubular portion, deviates from a central longitudinal axis of the processing device. Accordingly, the first substantially tubular portion preferably skews to one side of the processing device along its length in the distal direction.

Where the first substantially tubular portion is skewed to one side of the processing device, the filtered opening preferably faces the other side of the processing device. Accordingly, the filtered opening faces a void within the processing device, which void defines part of the second compartment.

The filtered opening suitably includes a filter for filtering the therapeutic product or biological sample. The filter may comprise any commercially available filter material, medium or media which is appropriate for centrifugal filtration. For instance, the filtration material, media or medium may comprise close-woven textiles, papers, nonwoven fabrics, metal screens or porous media. Preferably the filter is operable as a liquid filter to screen cells and retain them within the first compartment. For example, the filter material may have a pore size up to 20 μm, or in the range of 10 to 20 μm. Anything smaller is also usable, including protein filter size down to the kDaltons scale.

The filter and/or the filtered opening may be disposed across a shaped e.g. curved, or flat expanse of the side wall of the first substantially tubular portion. The filter and/or the filtered opening may extend to the distal end of the first substantially tubular portion. It is preferred that the filter and/or the filtered opening is elongate and preferably its length is narrower than its width. It is preferred that the filter and/or the filtered opening extends for a substantial proportion of the length of the first substantially tubular portion. Preferably, the length of the filter and/or the filtered opening is approximately half the length of the first substantially tubular portion. In alternative versions, the first substantially tubular portion may comprise more than two thirds the length of the first substantially tubular portion and optionally more than three quarters the length of the first substantially tubular portion.

The first compartment may have an operational volumetric capacity of approximately 5 mL to maximum fill level. It is preferred that the volumetric capacity of first substantially tubular portion of the first compartment comprises approximately 1 mL. The filter and/or the filtered opening may extend from the base of the first compartment to a location which corresponds to more than 100 μL. The first compartment may include indicia to indicate liquid levels.

The preferred surface area for the filter and/or the filtered opening is preferably at least 30% of the surface area of the first portion of first compartment.

The filter may be replaceable for re-use of the processing device. Alternatively, preferably, the processing device is single-use only.

Preferably, the first and second compartments comprise an inner compartment and an outer compartment respectively, wherein the inner compartment is disposed, at least in part, within the outer compartment. In this configuration, the second compartment surrounds the first compartment. Where the first substantially tubular portion is skewed then the void within the second compartment will define a convenient location for aspiration of the filtrate.

In a preferred form of the device, a needle guide and/or outlet port may be provided at or adjacent the void for selective removal of the filtrate from the second compartment. Preferably the processing device includes a second closure for the second compartment. Preferably the second closure is a sealable closure member. Preferably the second sealable closure permits aspiration of the filtrate through the sealable closure. For example, the second sealable closure may comprise a pierceable closure member, for example of resiliently deformable material capable of allowing passage of a needle while permitting closure of the passage on withdrawal of the needle by the resilient nature of the material. For example, the resiliently deformable material may be plastic material such as synthetic rubber, alternatively, natural rubber.

A needle guide may be provided to ensure appropriate and at least substantial alignment of the needle upon insertion into the second compartment. A needle guide may be used in conjunction with the second closure member.

The first compartment may also include a second substantially tubular portion, disposed proximally relative to the first substantially tubular portion. The second substantially tubular portion may make up the balance of the operational volume of the first compartment i.e. approximately 4 mL. The first and second substantially tubular portions preferably define a unitary vessel, such as an integrally formed vessel.

The second substantially tubular portion may have a substantially circular sidewall with its centre concentric with the central longitudinal axis of the processing device. The second substantially tubular portion is preferably a continuation of the first substantially tubular portion. In other words, the side wall of the first substantially tubular portion continues to form the side wall of the second substantially tubular portion, albeit with shape changes along the overall length of the first compartment.

In a preferred form of the invention, an inner substantially tubular portion of the processing device is comprised of at least the first and second substantially tubular portions. The inner tubular portion may be received, at least in part, within an outer substantially tubular portion. The second compartment is preferably defined between the inner and outer substantially tubular portions. Preferably the first compartment is larger in volume than the second compartment. This prevents all of the liquid passing from the first compartment into the second compartment during centrifugation, thereby retaining a residual amount of liquid in the first compartment to retain the cells/protein/biological sample immersed in liquid. For this reason, the inner substantially tubular portion may project proximally beyond the outer substantially tubular portion.

The inner and outer substantially tubular portions may be permanently connected or integrally formed. For example, the inner and outer substantially tubular portions may be interconnected at their proximal end regions. For instance, the inner substantially tubular portion may be fused to the outer substantially tubular portion. For instance, the inner and outer portions may be fuse-melted together. This, together with the first and second closures, as mentioned above and below, renders the processing device as a closed system where the first and second compartments are not readily accessible. The inner and outer substantially tubular portions are preferably commensurate in shape at their proximal end regions.

In an alternative form of the invention, the inner and outer substantially tubular portions may be integrally formed e.g. 3D printed.

Alternatively, the inner and outer portions may be threadingly engaged or some other fitment type e.g. snap fit.

The inner and outer substantially tubular portions may be formed of pyrogen-free plastic material. It is preferred that the inner and outer substantially tubular portions are formed of transparent plastic material. Suitably, the processing device is sterilised before use.

The proximal end of the device may be closed by a first closure. Preferably, the processing device includes a first sealable closure for the first compartment. Preferably, the sealable closure permits injection of the therapeutic product or biological sample through the sealable closure. For example, the sealable closure may comprise a pierceable closure member, for example of resiliently deformable material capable of allowing passage of a needle while permitting closure of the passage on withdrawal of the needle by the resilient nature of the material.

Preferably, a delivery/recovery port is provided at the proximal end region of the processing device. In a most preferred form, the delivery/recovery port is provided by the pierceable closure member. A needle guide may be associated with the closure member to ensure appropriate and at least substantial alignment upon the needle being inserted through the first closure member. There may be more than one needle guide to separate delivery from recovery to avoid needle contamination.

In a most preferred form of the invention, the needle guide is at least substantially aligned with the skewed, first substantially tubular portion. In this way, a needle injected into the first compartment is less likely to interfere with the tapering side wall of the first substantially tubular portion.

While the foregoing description refers to the first and second substantially tubular portion having a “side wall”, it will be appreciated that there may be more than one side wall, for example where the tubular portions have a square or rectangle cross-section. The inner substantially tubular portion preferably has a distal end wall. The proximal end is preferably closed, fully or at least in part by the first closure member.

The outer substantially tubular portion is sized to receive the inner substantially tubular portion. A proximal seat may be provided to seat the inner substantially tubular portion within. The outer substantially tubular portion is preferably closed at the distal end by the second closure member. The outer substantially tubular portion may be circular in cross section with a gradually reducing cross-sectional area from the proximal to the distal end. Accordingly, the outer substantially tubular portion may be frusto-conical.

The processing device may be further provided with an air vent. An air vent is required for an otherwise hermetically sealed processing device to permit the exhaust of air on injection of the therapeutic product or biological sample and/or to permit the introduction of an air on aspiration of the therapeutic product or biological sample.

The air vent is preferably in the form of a peripheral air vent. Preferably, the air vent is provided in the projecting portion of the inner substantially tubular portion which projects beyond the outer substantially tubular portion. The air vent may include a filter to permit gas exchange but block the passage of pathogens and/or contaminants. For example, the air vent may incorporate a hydrophobic membrane. The hydrophobic membrane most preferably has a 0.2 μm pore size to permit gas exchange but block the passage of pathogens.

In an alternative form of the invention, the first compartment may lie adjacent to the second compartment.

Therapeutic product may include any treatment, therapy or drug including biologics, with the exception of small molecules.

The cell processing may include cell reconstitution including cell washing, cell filtration and cell concentration.

Any of the features described below in connection with other aspects of the invention may have application to this aspect of the invention.

According to another aspect of the present invention, there is provided, a kit including assemblable components to define the processing device as set out above or below in connection with other aspects.

According to a related aspect to the first aspect of the present invention, there is provided a kit for a processing device for a therapeutic product or biological sample, the kit including assembleable components to define first and second compartments, such that in the assembled processing device, the first compartment is in fluid communication with the second compartment via a filtered opening, with the filtered opening arranged in or along a first substantially tubular portion of the device.

According to a related aspect of the first aspect of the present invention, there is provided a method for processing a therapeutic product or biological sample using centrifugation wherein the method includes:
delivery of the product or sample to the first compartment,
removal of filtrate from the second compartment; and
recovering a processed product from the first compartment.

In accordance with the second aspect of the present invention, there is provided a processing device for a therapeutic product or biological sample, the processing device including a first compartment and a second compartment wherein the first compartment is in fluid communication with the second compartment via a filtered opening, wherein the first compartment and the second compartment are defined by container portions which are permanently connected or integrally formed.

For instance, the processing device may be formed by an inner substantially tubular portion and an outer substantially tubular portion. The inner substantially tubular portion may define, at least in part, the first compartment. The second compartment may be defined, at least in part, between the inner and outer substantially tubular portions.

The inner and outer substantially tubular portions may be separately formed and permanently connected in a subsequent processing step. The inner and outer substantially tubular portions may be permanently connected at their proximal end regions.

Furthermore, the processing device may be closed at opposite ends by resiliently deformable closure members. A first closure member may be provided to close the first compartment. A second closure member may be provided to close the second compartment.

The container portions may be formed by a process of additive manufacturing e.g. 3D printed.

According to a related aspect of the second aspect of the present invention, there is provided a method for processing a therapeutic product or biological sample using centrifugation wherein the method includes:
delivery of the product or sample to the first compartment,
removal of filtrate from the second compartment; and
recovering a processed product from the first compartment.

Any of the features described above in connection with the first aspect of the invention or other aspect(s) below may have application to this aspect of the invention.

In accordance with a third aspect of the present invention, there is provided a processing device for a therapeutic product or biological sample, the processing device including an inner portion which is substantially tubular and an outer portion which is substantially tubular, the inner portion being received or receivable, at least in part, within the outer portion, such that at least a portion of the inner portion is offset from a central longitudinal axis or centreline of the outer substantially tubular portion.

Preferably, the processing device is adapted for centrifugation.

Furthermore, the inner and outer substantially tubular portions may be closed by closure members. In a preferred form of the invention, the inner and outer substantially tubular portions are closed by respective closure members. The closure members may be disposed at opposite ends of the processing device. The closure members may be resiliently deformable closure members.

Preferably, the inner and outer substantially tubular portions define inner and outer compartments. Preferably, the inner compartment is in fluid communication with the outer compartment via a filtered opening. A first closure member may be provided to close the first compartment. A second closure member may be provided to close the second compartment.

Preferably, the offset of the inner substantially tubular portion at least substantially aligns with a needle guide for sample delivery and/or recovery. Additionally or alternatively, locating indicia on one of the closure members may indicate the preferred needle entry point.

Preferably, a void is created by the offset of the inner substantially tubular portion within the outer substantially tubular portion. Preferably, a needle guide for fluid aspiration at least substantially aligns with the void. Additionally or alternatively, locating indicia on the resiliently deformable closure member may at least substantially align with the void.

The processing device may be provided in the form of a kit.

Any of the features described above in connection with other aspects of the invention may have application to this aspect of the invention.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

In order that the invention may be more fully understood, one embodiment will now be described, by way of example, with reference to the figures in which:

FIG. 1 is a diagrammatic illustration of the prior art process of reconstituting of small-volume cell therapies;

FIG. 2A is a side elevation of a processing device in accordance with a preferred embodiment of the present invention;

FIG. 2B is a side elevation of a processing device as shown in FIG. 2A, with additional features referenced;

FIG. 2C is a detailed view of a portion of FIG. 2A;

FIG. 3A is a side elevation of the processing device as shown in FIG. 2A, with reference to some additional features;

FIG. 3B is a side elevation of the processing device, similar to that shown in FIG. 2A, with reference to the section plane A-A of FIG. 3C;

FIG. 3C is a cross-sectional view through A-A of FIG. 3B;and

FIG. 3D is a side elevation of the processing device as shown in FIG. 3B, with reference to some additional features;

FIG. 3E is a cross-sectional view through B-B of FIG. 3D;

FIG. 3F is a cross-sectional view through C-C of FIG. 3C;

FIG. 4 is a diagrammatic illustration of the process for reconstituting of small-volume cell therapies using the device of FIG. 2A;

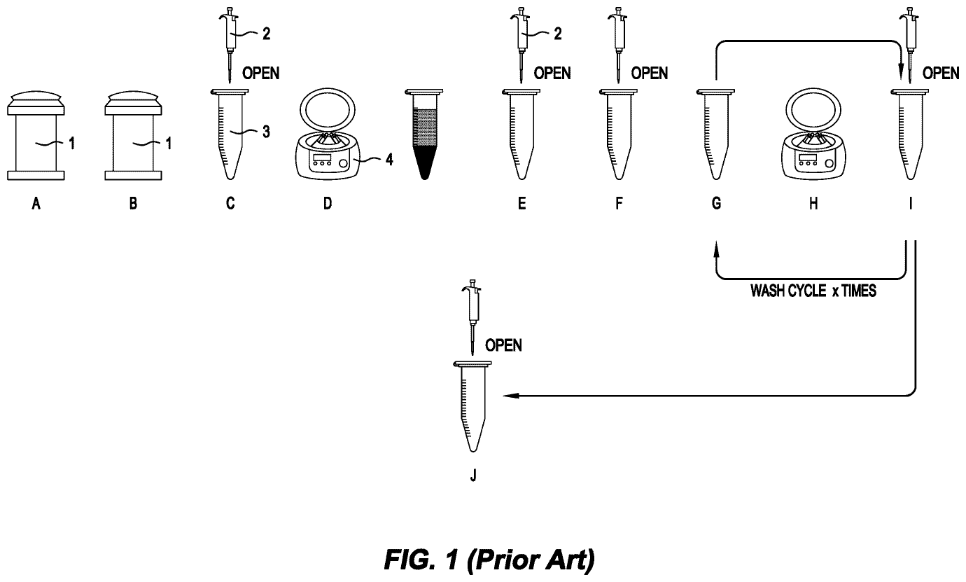

### DETAILED DESCRIPTION OF THE EMBODIMENTS

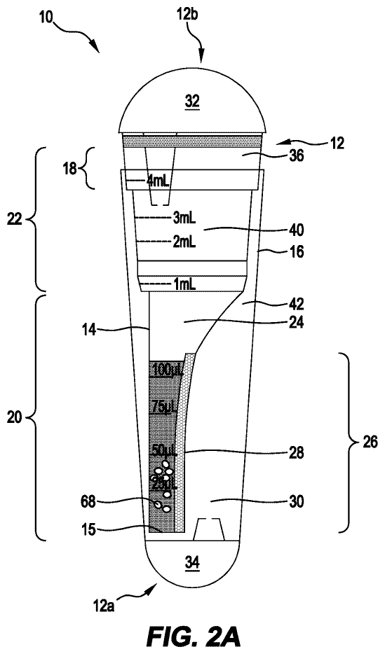

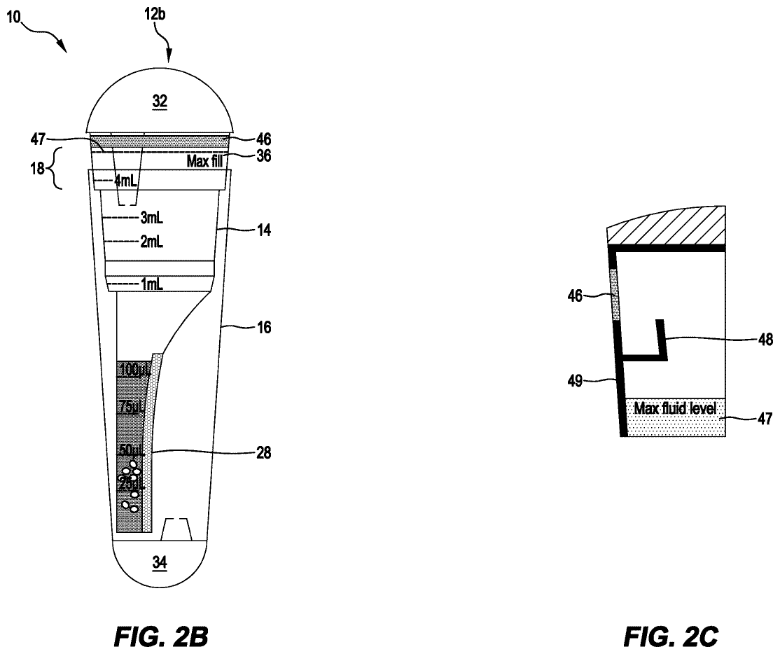

As shown in FIG. 2A, a processing device 10 in accordance with a preferred embodiment of the present invention is generally in the form of a closed container 12. The closed container 12 is intended for centrifugation. Accordingly, the closed container 12 has a distal end 12a and a proximal end 12b. The proximal end 12b is intended to be located radially inwardly from the distal end 12b during centrifugation.

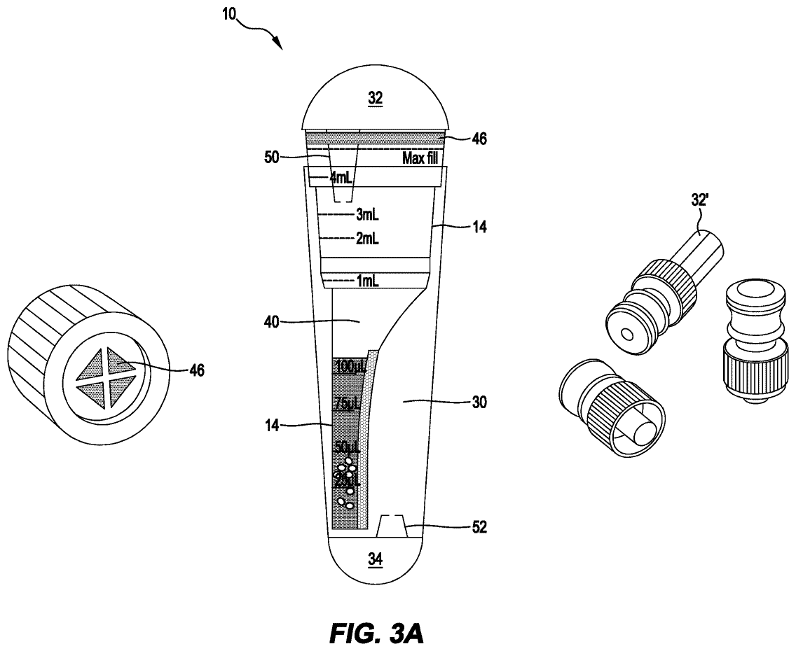

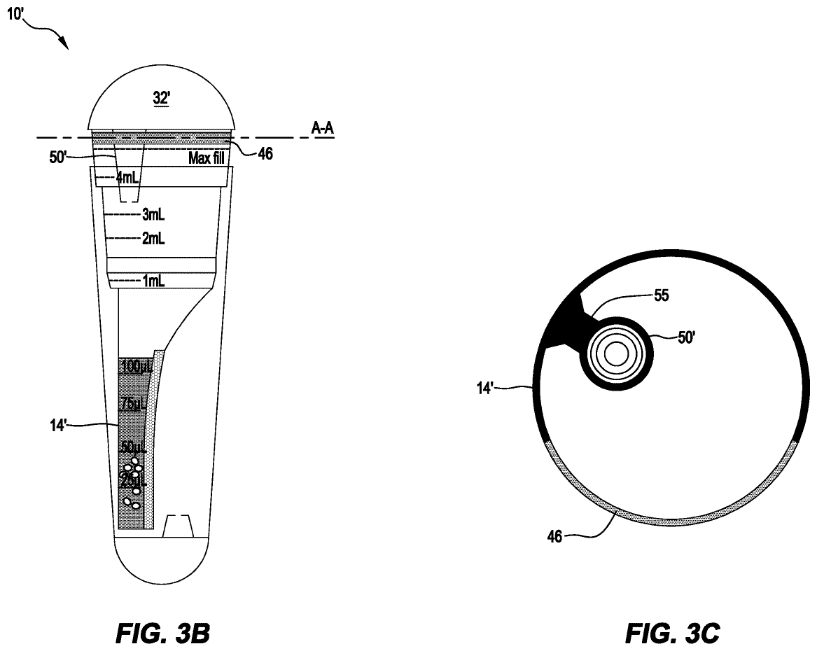

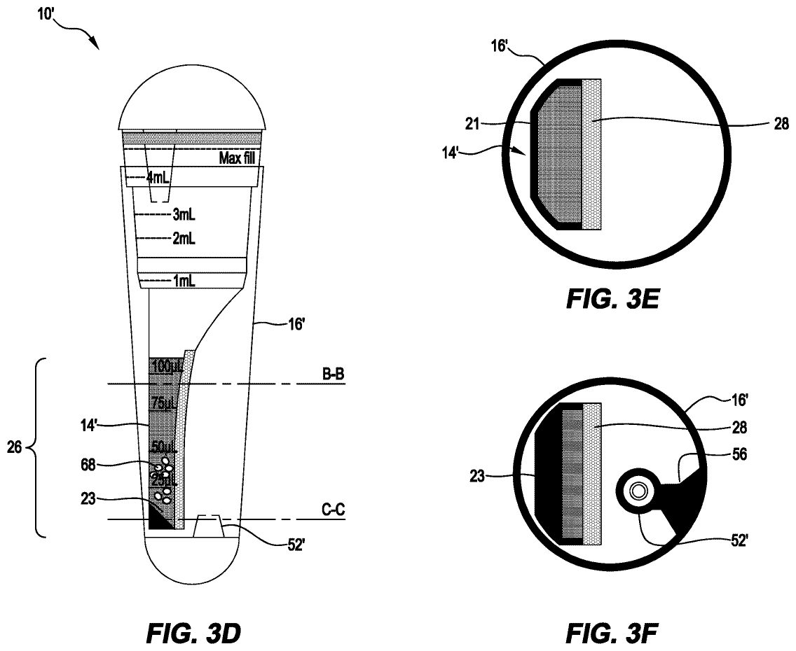

The closed container is made up of an inner portion 14 which is substantially tubular (hereafter “inner tubular 14”) and an outer portion 16 which is substantially tubular (hereafter “outer tubular 16”). The inner tubular 14, for the most part, is received within the outer tubular 16. The inner and outer tubulars 14, 16 may be separately manufactured from suitable plastics material and then fused together. The outer tubular 16 is substantially frusto-conical in shape, having an opening at the proximal end 12b. The outer tubular 16 may have an opening at the distal end 12a (but closed by resiliently deformable closure member 34 as will be explained). The outer tubular 16 may include a needle guide 52 (as will be explained in connection with FIG. 3A and 3F).

A proximal end region 18 of the inner tubular 14 has an external shape which is commensurate with the internal shape of the outer tubular 16. Accordingly, the inner tubular 14 will be seated within the outer tubular 16 by virtue of the gradual reduction in cross-sectional area extending in the distal direction of both the inner and outer tubulars 14, 16. Thus the two parts have a tapered fit. The inner tubular 14 is thus nested within the outer tubular 16. The inner and outer tubulars 14, 16 may be fused together in this configuration by hot melting or similar process.

The inner tubular 14 is comprised of a first substantially tubular portion 20 and a second substantially tubular portion 22. The first tubular portion 20 is arranged distally of the second tubular portion 22. The first and second tubular portions 20, 22 are both defined by a side wall which extends from the proximal end 12b to the distal end 12a, with a reduction in cross-sectional area from the proximal end 12b to the distal end 12a. Along parts of the length, the reduction in cross-sectional area is gradual, whereas in other parts along the length, there may be a step-change in the cross-sectional area, as shown in the figures.

The first tubular portion 20 has a proximal portion 24 which gradually decreases in cross-sectional area in the distal direction. However, the decrease in cross-sectional area is such that the centre of each cross-section progressively moves toward one side (to the left as shown in FIG. 2A).

The first tubular portion 20 also has a distal portion 26 which extends from the proximal portion 24, distally toward the distal end of the first tubular portion 20. The distal portion decreases in cross-sectional area along at least a portion of its length. The distal portion 26 continues distally on the offset trajectory established by the skewed proximal portion 24, such that the first tubular portion 20 extends down one side of the container 12. A straight line is maintained on one side (the left side in FIG. 2A) along the first tubular portion 20. The longitudinal centreline of the first tubular portion 20 is therefore offset from the central longitudinal axis of the outer tubular 16, and for that matter, the central longitudinal axis of the container 12 as well.

As shown in FIG. 3E, the distal portion 26 is shaped in the form of a shell 21 which is C-shaped in cross-section. The filter material 28 extends across the outer edges of the C-shaped shell 21. The C-shaped shell 21 approximates the cylindrical inner periphery of the outer tubular 16′, on the side (the left side in the Figures) which is adjacent to the inner tubular 14′.

As shown in FIG. 2A, the distal most end of the distal portion 26 is closed with an end wall 15. As shown in the variation of FIGS. 3D and 3F, the distal most end of the distal portion 26 has an internal ramp 23. This ensures that the cells 68 are guided towards the filter 28 to avoid a dead zone where the cells 68 do not receive washing.

### Filter and Compartments

On the other side of the distal portion 26 (the right side in FIG. 2A), a filtered opening 28 is provided. The filtered opening 28 is elongate and extends the full length of the distal portion 26. Having a large filtered opening minimises clogging of the filter material 28. The filter is preferably a <=20 μm filter which is moulded into the side wall of the first tubular portion 20. For example, the inner tubular 14 may be formed in a process of over-moulding onto an existing filter piece.

As shown in FIG. 2A, the filtered opening 28 faces a void 30 which is created within the container 12 by the offset first tubular portion 20.

The inner tubular 14 is closed at its proximal end 12b by a resiliently deformable closure member 32. The outer tubular 16 may be closed at its distal end 12a by a resiliently deformable closure member 34.

The inner and outer tubulars 14, 16 together with the closure members 32, 34 define a closed container 12. Within the closed container 12, the inner tubular 14, the end wall 15 and the closure member 32 define an inner compartment 40. An outer compartment 42 is defined between the inner and outer tubulars 14, 16, the end wall 15 and the closure member 34. The outer compartment 42, at least partially surrounds the inner compartment 40.

The distal end wall 15 of the inner tubular 14 terminates short of the distal end of the outer tubular 16. On the other hand, the proximal end of the inner tubular 14 projects by a relatively short projection 36 beyond the proximal end of the outer tubular 16. The relatively short projection 36 in this case ensures that the volume of the inner compartment 40 exceeds the outer compartment 42.

### Air Vent

FIGS. 2B and 2C illustrates a peripheral air vent 46 provided in the container 12. The peripheral air vent 46 is disposed in the projecting portion 36 in the proximal end region 18. However, the air vent 46 could also be disposed in the closure member 32. The air vent 46 permits egress of air on injection of a sample or therapeutic product into the container 12 and also permits aspiration of air into the container when the filtrate and/or residue is aspirated from the container 12. This permits pressure equalisation during delivery of sample/product into, and aspiration of filtrate/residue/recovered product out of the otherwise hermetically sealed container. The air vent is preferably a filter in the form of a hydrophobic membrane having a pore size of 0.2 μm which allows gas exchange but blocks pathogens from exiting the container 12 and/or contaminants from entering the container 12. The therapeutic product injected should be sterile, so the air vent's function is to allow pressure equalization when injecting/aspirating but block pathogen entry from the outside.

Additionally, as shown in FIG. 2B, the air vent 46 is disposed above the “maximum fill” line 47 which indicates the maximum operational volumetric capacity of the inner tubular 14 (in this example, 5 mL). Between the air vent and the maximum fill line 47, a vent protector 48 is provided. The vent protector 48 is in the form of a peripheral channel formed with the side wall 49 of the inner tubular 14. The channel may extend adjacent to the air vent 46. The extent of the channel may substantially correspond only to the extent of the air vent 46. Alternatively, the channel may be circumferential.

Additionally, the inner tubular 14 is marked with indicia to indicate the fill level. Of the 5 mL maximum operational volumetric capacity (as marked) of the inner tubular 14, 1 mL is allocated to the first tubular portion 20, whereas the remaining 4 mL is allocated to the second tubular portion 22. Overall, the inner tubular 14 has a capacity of more than 5 mL, although the maximum marked filling capacity is 5 mL to ensure that the maximum fill level is below the air vent 46.

### Capacity

The operational capacity of the inner compartment 40 of the inner tubular 14 (in this case 5 mL) is larger than the capacity of the outer compartment 42 (in this case, 4.5-4.9 mL). This ensures that following centrifugation, a residual amount of liquid must remain in the inner compartment 40. Thus, where the liquid undergoing centrifugation contains biological cells, these cells will remain in liquid at the conclusion of centrifugation. By varying the volumetric difference between the inner and outer compartments, the processing device can be tuned to retain a different volume of residual liquid in the inner compartment. This is functionally very handy as some application may desire 0.1-0.5 ml final volume, for example. Other global dimensions are envisaged for other applications. Different versions of the processing device could be available to offer different volume of residual liquid in the inner compartment, depending on the version. There could be a mini, midi and maxi version.

### Closures

FIG. 3A shows the form of the closure members 32, 34. The closure members 32, 34 are in the form of compressed synthetic material, generally known as a “bung”. These closure members 32, 34 are formed of resiliently compressible material to allow needle penetration for delivery and aspiration of the product/sample as will be subsequently explained. The closure members 32, 34 are additionally provided with a needle guide 50, 52. The closure members 32 with incorporated needle guides 50, 52 can be any of several known brands, typically used as needle ports for IV bags. For instance, a suitable proprietary needle entry port 32′ is provided by Medidose (https://www.medidose.com/injection-port4.aspx). See for instance, FIG. 3A, right-hand side of the figure.

Thus, the closure members 32, 34 serve multiple functions, firstly as closure members for the container 12, secondly as delivery and aspiration ports for syringe delivery and aspiration from the container, and thirdly, as needle guides for the syringe needles.

### Needle Guides

As can be seen in FIGS. 2A and 3A, the needle guide 50 is aligned with the offset axis of the first tubular portion 20. On delivery of the sample/therapeutic product, as will be subsequently explained, the delivery needle will be able to enter the inner compartment 40 without hitting the side wall of the first tubular portion 20 as it skews toward the left as shown in the figures. Additionally, during recovery, the inserted needle will be directly in line with the distal portion 26 to recover cells and/or other residual liquid which has not passed through the filter 28.

Conversely, the distal needle guide 52 is provided within or facing the void 30. This provides a space for entry of the syringe needle for filtrate removal from the void 30.

Suitably, the inner and outer tubulars 14, 16 are transparent to enable the laboratory technician/surgeon to view the contents of the container 12 and watch the passage of the delivery and recovery needles. (However the process could also be automated).

FIGS. 3B and 3C illustrate an alternative form of processing device 10′ where the needle guide 50 is incorporated into the container 12, specifically into the inner tubular 14′. In this form of the invention, the needle guide 50′ is not incorporated into the closure member 32. Instead, the needle guide 50′ is grafted onto the inner tubular 14′. Specifically, the side wall of the inner tubular 14′ has a radially inwardly extending projection 55 with the needle guide 50′ supported by the projection 55. The side wall of the inner tubular 14′, the projection 55 and the needle guide 50′ may be integrally formed, e.g. moulded from plastics material.

FIGS. 3B and 3C also illustrate the form of the peripheral air vent 46 in the shape of an arc.

Similarly, FIG. 3E and 3F illustrate respective cross-sections through the planes B-B and C-C of FIG. 3D. The needle guide 52′ is incorporated into the container 12, specifically into the outer tubular 16′. The needle guide 52′ is grafted onto the outer tubular 16′. The side wall of the outer tubular 16′ has a radially inwardly extending projection 56 with the needle guide 52′ supported by the projection 56. The side wall of the outer tubular 16′, the projection 56 and the needle guide 52′ may be integrally formed.

It will be understood that like reference numerals will be used to illustrate like parts. However, the addition of the symbol (′) will illustrate where a part has been modified for a variant or second embodiment.

### Workflow

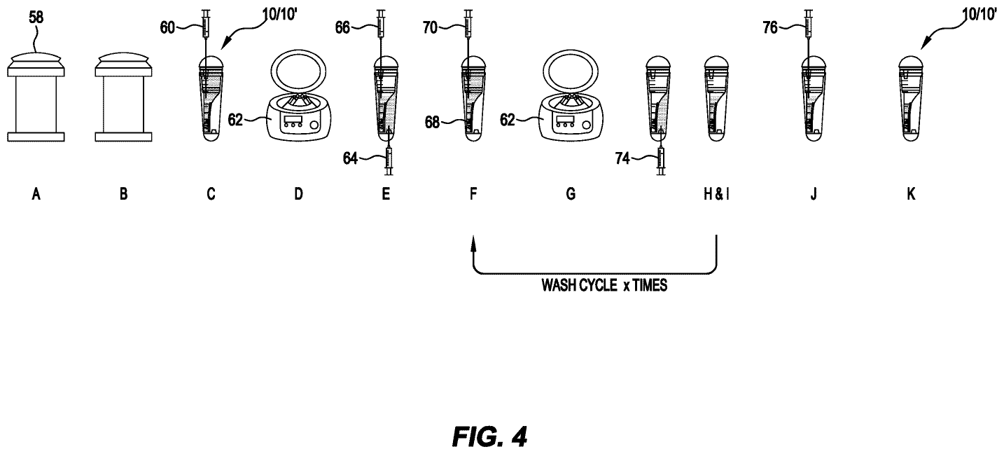

In order that the invention may be more fully understood, the workflow using the processing device 10, 10′ will be illustrated with reference to FIG. 4. FIG. 4 illustrates an end-to-end workflow of the reconstitution of a frozen cell therapeutic product, which is thawed, washed to remove the cryopreservative, and concentrated to a therapeutic dose for handover to the surgical team. This is a specific and preferred implementation. However, the invention extends beyond this specific implementation and may have many other uses in workflows requiring centrifugation.

As shown in FIG. 4A, the frozen cells are delivered in a cryo-preservative such as DSMO in a cryocontainer 58 (the one shown is simply one of many commercially available small volume cryovials). The cells are thawed in the cryocontainer 58 as shown in FIG. 4B.

As shown in FIG. 4C, a syringe 60 is used to aspirate the contents of the cryocontainer 58 and deliver them to the processing device 10. The syringe 60 may be part of an autosampler. The needle of the syringe 60 pierces through the closure member 32 and into the inner compartment 40 within the inner tubular 14. The contents of the syringe 60 are therefore deposited into the inner compartment 40. The needle is typically a 20 gauge needle.

As shown in FIG. 4D, the processing device 10 is then placed in the centrifuge 62. The effect of the centrifugation will be that some of the cryopreservative will pass through the filtered opening 28 and into the outer compartment 42.

As shown in FIG. 4E, the cryopreservative can then be removed through use of a syringe 64, the needle of which is inserted through the distal closure member 34 and into the void 30. Additionally, excess cryopreservative can be removed by syringe 66, the needle of which is inserted into the inner compartment 40 since the cells of the therapeutic product 68 will have moved to a distal region of the inner compartment 40 and therefore, the excess cryopreservative can be removed from the inner compartment 40 without disturbing the cells 68. As shown, prior to the introduction of the fresh suspension in FIG. 4F, the outer compartment 42 has been depleted of the cryopreservative. Complete removal is impossible, but this step and further washes have the intended functional effect of diluting DMSO down to an acceptable very low concentration (that is usually mandated by regulators/pharmacopeias depending on target tissue or organ).

As shown in FIG. 4F, the syringe 70 delivers a fresh suspension solution, e.g. Ringers, for the therapeutic product. Syringe 70 delivers the fresh suspension via a needle inserted through the proximal closure 32, the proximal needle guide 50 and into the inner compartment 40.

As shown in FIG. 4G, the processing device 10 is then placed in the centrifuge. Following centrifugation, some of the suspension solution will pass through the filtered opening 28 and into the outer compartment 42. The cells 68 of the therapeutic product remain in the inner compartment 40. A distal syringe 74 is then inserted through the distal closure 34 and distal needle guide 52 to drain waste suspension from the void 30. As shown in FIG. 4, this wash cycle is repeated a number of times as will be determined by a person skilled in the art, depending upon the therapeutic product, the level of residual removal required, the particular cryopreservative concentration to be achieved, etc.

As shown in FIG. 4J, excess suspension is then removed from the inner compartment 40 via proximal syringe 76. The amount of suspension removed depends upon the desired concentration for the therapeutic product. The therapeutic product is then ready for handover to the surgical team. Use of the same processing device 10 to hand over to the surgical team avoids another container, minimising an additional step, container wastage and reduces the possibility of contamination. Further, the fusing of the inner and outer tubulars 14, 16 means that they cannot be separated which also reduces the risk of contamination or tampering.

The syringes 60, 64, 66 etc may be separate sterile syringes or alternatively may be the same syringe sterilized between the processing steps as is known in the art. Syringes may be dedicated to delivery/removal of respective liquids.

The advantages of the preferred embodiment are as follows:

### 1. Closed Cellular Custody

Valuable cells are never in contact with external environment and so minimizes biocontamination risk and lowers environmental control requirements which is important in a regulatory framework. One container all the way from post-thaw to surgical handover also minimizes cell loss.

### 2. Simple to Use

There are no operator-dependent pipette skills. The only process operations are centrifuge and needle injection or aspiration, made easy by design.

### 3. Scalability

Applicable in research, development, clinical or GMP settings. Simple-to-automate operations are envisioned for future at-scale use.

### 4. Address Growing Unmet Need

Cell and gene therapies will increasingly target solid tissues and organs, and hence require small volume reconstitution at the therapeutic delivery stage.

It will be understood that the invention disclosed and defined in this specification extends to all alternative combinations of two or more of the individual features mentioned or evident from the text or drawings. All of these different combinations constitute various alternative aspects of the invention.

1. A processing device for a therapeutic product or biological sample, the processing device provided with a proximal end and a distal end and including first and second compartments, the processing device including a first substantially tubular portion, wherein the first compartment is in fluid communication with the second compartment via a filtered opening which is arranged in or along the first substantially tubular portion.

2. The processing device as claimed in claim 1 wherein the first substantially tubular portion defines a side wall of the first compartment, with the filtered opening provided in the side wall.

3. The processing device as claimed in claim 1, wherein the filtered opening is elongate, the elongate extent of the filtered opening being oriented to generally align with the lengthwise direction of the first substantially tubular portion.

4. The processing device as claimed in claim 1 wherein the first substantially tubular portion has transverse cross-sections and the centroid of the transverse cross-sections, along at least a portion of the length of the first substantially tubular portion, deviates from a central longitudinal axis of the processing device.

5. The processing device as claimed in claim 4, wherein the cross-sectional area of the transverse cross-sections decreases toward the distal end, for at least a portion of the length of the first substantially tubular portion.

6. The processing device as claimed in claim 1 wherein a portion of the first substantially tubular portion, towards the distal end, is skewed to one side of the processing device.

7. The processing device as claimed in claim 6, further including a first needle guide which is at least substantially aligned with said skewed portion of the first substantially tubular portion.

8. The processing device as claimed in claim 6, wherein the filtered opening preferably faces the other side of the processing device to face a void within the processing device, which void forms part of the second compartment.

9. (canceled)

10. The processing device as claimed in claim 1 wherein the first and second compartments comprise an inner compartment and an outer compartment respectively, wherein the inner compartment is disposed, at least in part, within the outer compartment.

11. (canceled)

12. The processing device as claimed in claim 8 wherein a second needle guide and/or outlet port is provided at or adjacent the void for selective removal of the filtrate from the second compartment.

13. The processing device as claimed in claim 1 wherein the processing device further includes a second closure for the second compartment, the second closure comprising a sealable closure such that the second sealable closure permits aspiration of filtrate through the sealable closure.

14-18. (canceled)

19. A kit including assemblable components to define the processing device as claimed in claim 1.

20. A kit for a processing device for processing a therapeutic product or biological sample, the kit including assembleable components to define first and second compartments, such that in the assembled processing device, the first compartment is in fluid communication with the second compartment via a filtered opening, with the filtered opening arranged in or along a first substantially tubular portion of the device.

21. (canceled)

22. A processing device for a therapeutic product or biological sample, the processing device including a first compartment and a second compartment wherein the first compartment is in fluid communication with the second compartment via a filtered opening, wherein the first compartment and the second compartment are defined by container portions which are permanently connected or integrally formed.

23. The processing device as claimed in claim 22 wherein the container portions include an inner portion which is substantially tubular and an outer portion which is substantially tubular, the inner portion defining, at least in part, the first compartment and the second compartment being defined, at least in part, between the inner and outer portions.

24-25. (canceled)

26. A processing device for a therapeutic product or biological sample, the processing device including an inner portion which is substantially tubular and an outer portion which is substantially tubular, the inner portion being received or receivable, at least in part, within the outer portion, such that at least a portion of the inner portion is offset from a central longitudinal axis or centreline of the outer substantially tubular portion.

27. (canceled)

28. The processing device as claimed in claim 26, wherein the inner portion has transverse cross-sections and the centroid of the transverse cross-sections deviates from a central longitudinal axis of the processing device, along at least a portion of the length of the inner portion.

29. The processing device as claimed in claim 28 wherein the inner and outer portions define inner and outer compartments and the inner compartment is in fluid communication with the outer compartment via a filtered opening.

30. The processing device as claimed in claim 26, wherein the offset portion at least substantially aligns with a first needle guide for sample delivery and/or recovery.

31. The processing device as claimed in claim 30 wherein inner portion is closed by a first closure which is resiliently deformable and locating indicia is provided on the first closure, wherein the indicia, at least substantially aligns with the first needle guide.

32. The processing device as claimed in claim 26, wherein a void is created within the outer portion, by the offset portion, and a second needle guide at least substantially aligns with the void.

33. (canceled)

34. The processing device as claimed in claim 26, provided in the form of a kit, whereby the inner and outer portions are discrete portions which are assemblable with the inner portion at least partly received within the outer portion.
